(19) United States
(12) Patent Application Publication
(10) Pub. No.: US 2005/0021527 A1
(43) Pub. Date: Jan. 27, 2005

(54) System for resource accounting for multiple entities in an arbitrary value chain

(76) Inventors: Jian Zhang, Morgan Hill, CA (US); Stephen Chan, Los Altos, CA (US)

Correspondence Address: RONALD CRAIG FISH, A LAW CORPORATION, PO BOX 820, LOS GATOS, CA, 95032, US

(21) Appl. No.: 10/617,490

(22) Filed: Jul. 10, 2003

(51) Int. Cl. G06F 17/00

(52) U.S. Cl. 707/100

(57) ABSTRACT

The inventive system includes a method to let participants in a value chain of digital and physical goods to package resources into sellable services and products, keep track of consumption of the resources and calculate charges to the end users and revenues to all participants. The participants to such supply chain include but not limited to resource suppliers, distributors, aggregators, resellers and service providers. The resources include but not limited to digital goods such as computing capacity, storage, content, software applications, data depository or special data acquisition instruments and physical goods such as commodity and manufactured items. Through this invention, resource supplies and consumptions and thus charges and revenues can be tracked and accounted for simultaneously. Any participants to the supply chain can host such system on behalf of itself and other participants. A participant can package resources into sellable units, track the resource supply by its suppliers and consumption by its customers, determine end users charges and revenues according to pricing structures and business rules including end user charges, loyalties, commissions, reseller fees, and roaming tariff, etc. When compared with the traditional methods, this invention tracks in real time all resource supplies and consumptions across the value chain simultaneously, in both actual resource unit and economic value. The invention can be realized in a combination of both hardware and software.

### U.S. PATENT DOCUMENTS CITED

U.S. Pat. No. 6,047,267 Apr. 4, 2000 Owens, et al.

U.S. Pat. No. 6,182,054 Jan. 30, 2001 Dickinson, et al.

U.S. Pat. No. 6,199,047 Mar. 6, 2001 Dimino, et al.

U.S. Pat. No. 6,320,947 Nov. 20, 2001 Joyce, et al.

U.S. Pat. No. 6,381,316 Apr. 30, 2002 Joyce, et al.

### REFERENCES

Publications Cited

R. Buyya, D. Abramson and J. Giddy, “An Economy Grid Architecture for Service-Oriented Grid Computing,” 10th IEEE International Heterogeneous Computing Workshop (HCW 2001).

R. Buyya, D. Abramson and J. Giddy, “A Case for Economy Grid Architecture for Service Oriented Grid Computing,” 10th IEEE International Heterogeneous Computing Workshop (HCW 2001), in conjunction with IPDPS 2001, San Francisco, Calif., USA, April 2001.

R. Buyya, H. Stockinger, J. Giddy and D. Abramson, “Economic Models for Management of Resources in Peer-to-Peer and Grid Computing,” SPIE International Symposium on The Convergence of Information Technologies and Communications, Aug. 20-24, 2001, Denver, Colo.

R. Buyya and S. Vazhkudai, “Computer Power Market: Towards a Market-Oriented Grid,” The First IEEE/ACM International Symposium on Cluster Computing and the Grid (CCGrid 2001), Brisbane, Australia, May 16-18, 2001.

### BACKGROUND OF THE INVENTION

1. Field of the Invention

The present invention relates generally to package resource into sellable services and track resource supplies and consumptions across multiple supplier-customer relationships across an arbitrary value chain of digital and physical goods. The applications include but are not limited to grid computing, web services, mobile wireless services, consumer broadband access, electronic commerce, market place, electrical utility services, e-commerce, traditional wireline telephony and many other supply chains for physical goods. Specifically, it relates to techniques that use multiple accounting engines, virtual or otherwise, to keep track of multiple supplier-customer relationships over the whole value chain and determine the economic value according to the pricing structures and business rules.

2. Description of the Prior Art

Existing solutions are designed to keep track of and account for resources across one-tier of value chain, typically between a supplier and a custom using a single accounting systems. These solutions can be categorized into three types: enterprise account receivable (A/R) and account payment (A/P) software, billing systems used by service providers and allocation management software used in high performance computing.

More specifically, A/R and A/P are traditionally designed to keep track of small-number coarse-grain transactions and are not designed to support services that involve a large number of fine grain transactions. Furthermore, A/R and A/P can only track resource consumptions over one tier of value chain.

Likewise, billing systems or rating engines keep track of the resource consumption by the end consumers of resources owned by resource providers and determines the appropriate charges for the consumers. Because of this single-tier focus, existing solutions are designed to be deployed by a service provider to keep track of transactions between the service provider and the end consumers. Resource consumption between the service provider and its immediate end consumers is recorded with a Resource Detail Record (RDR) that describes the end consumer ID and the types and quantities of resources consumed. The RDR from the mediation to the rating engine do not need to explicitly record the seller because there is only one seller.

Because this deployment architecture is only meant to measure the transaction between one tier of business relationship, i.e. the direct transactions between the service provider and the end consumers, the data model in the rating engine do not have to explicitly model the seller of services, i.e. the service provider. Products do not need to be explicitly linked to a seller because there is only one seller in the system, i.e. the service provider. Debits are accumulated to the end consumers who owe the service provider but there is no need to explicitly record credits because all credits go to the default seller, the service provider.

### SUMMARY OF THE INVENTION

Modern value chains of network services, digital goods and physical goods often consist of multiple tiers of supplier-customer relationships. As such it is economically inefficient and unnecessary to have every participant in the value chain to deploy resource-tracking systems such as billing systems, rating engines and account receivable and account payable software. Furthermore, some of these transactions span multiple supplier-customer relationships and need to be tracked simultaneously.

This invention enables resource tracking and accounting across the whole supply chain, over multiple supplier-customer relationships simultaneously. Resource consumption across each customer-supplier relationship is recorded with a Resource Detail Record (RDR) that describes the associated parameters including, but not limited to, supplier and customer involved, time of the transaction, the end user involved, the services or goods involved and the amount of resource involved. The inventive system imports these usage records and determines the charges and revenues for all participants involved in the value chain.

The inventive system can be hosted by one of the participants in the value chain or by an independent entity to keep track of resources on behalf of the whole value chain.

To enable resource tracking for a transaction that crosses multiple business boundaries, a Resource Data Record is created for each transaction. Each RDR contains fields that have identification codes for every business or other entity involved in a transaction with transactions involving more than two participants having multiple tiers each of which is between two different entities identified in the RDR. It also contains fields which store data that define the type of resource consumed, a timestamp indicating when the transaction occurred, and a field that stores the number of units of the resource consumed in the transaction.

To do the necessary accounting for each transaction, the RDR for the transaction is used in conjunction with another data structure inside a rating engine to carry out an accounting process for each pair of buyers and sellers or each pair of entities involved in a transaction where there are terms that control the financial relationship between the entities. These terms are recorded in a price plan object in the data structure inside the rating engine. The rating engine is a software object with functions that carry out the accounting process and a data structure. The data structure in the rating engine has: a participant object that stores the identity and attributes for each participant in the value chain, a balance object that records the balance of debits and credits as between each pair of participants that define a tier of the transaction with pointers linking the balance object to each of the pair of participant objects for which the balance is pertinent, one or more product type objects which record the types of products or services that can be involved in transactions with pointers to the seller participant objects which can sell these types of products and services, one or more product instance objects which record the particular instance of products, each instance object having a pointer to the pertinent product type object, one or more price plan objects that record data regarding the price per unit of a product or service consumed of a particular product instance, each price plan object having pointers to the pertinent product type and product instance objects. Participant objects can identify sponsors, claimants, suppliers, customers of the suppliers, consumers or end users of the product or service, distributors, retailers, etc. There will be a balance object as between each seller and buyer, as between each sponsor and an associated seller, as between each claimant and an associated seller, etc. There will be a price plan object in the data structure for each pair of entities that have a financial relationship and which have participant data objects in the data structure.

The accounting process carried out by the rating engine processes one tier in the value chain at a time. It first identifies the buyer participant by reading the consumer ID in the RDR. It then identifies the seller by reading the customer ID in the RDR. It then identifies a product type sold in this transaction using the resource type field in the RDR. It then identifies the pertinent product instance using the buyer data object and the product type in any of several ways. It then identifies the pertinent price plan using pointers in the pertinent product instance and product type objects. It then calculates the payment amount by multiplying the price per unit consumed obtained from the price plan object times the number of units consumed from the pertinent field in the RDR. Then, using pointers in the pertinent participant objects in the data structure in the rating engine, the appropriate balance object is found, and the payment amount just calculated is added or subtracted as appropriate to the balance object.

The accounting process then determines if there is another tier to the transaction by checking if there are any more entity identification codes in the RDR other than the ones just processed. If there are, the next tier in the value chain is processed in the manner described above by making a copy of the RDR with the identification codes of the two entities on the next tier written into the consumer and customer ID fields, or by shifting the ID fields in the current ID appropriately so that the ID codes of the entities on the tier to be processed are in the consumer and customer ID fields of the original RDR.

### BRIEF DESCRIPTION OF THE DRAWINGS

FIG. 1 shows the current business relationship between the service provider (or vendor) and the end consumers. The relationships are single-tiered.

FIG. 2 shows the provision (by the service provider) and consumption (by end consumers) of resources in the current business relationship. The service provider is the only one providing resources and the end consumers are the ones consuming resources. Therefore, the service provider is always the seller and the end consumers are always the buyers.

FIG. 3 shows the current application deployment architecture where each service provider deploys its own mediation and rating engine to measure the usage from the network it provides. Mediation system collects and correlates transaction data from the network and generates RDR that record the resource usage types and quantities.

FIG. 4 shows the current typical format of a RDR generated by mediation system to the rating engine.

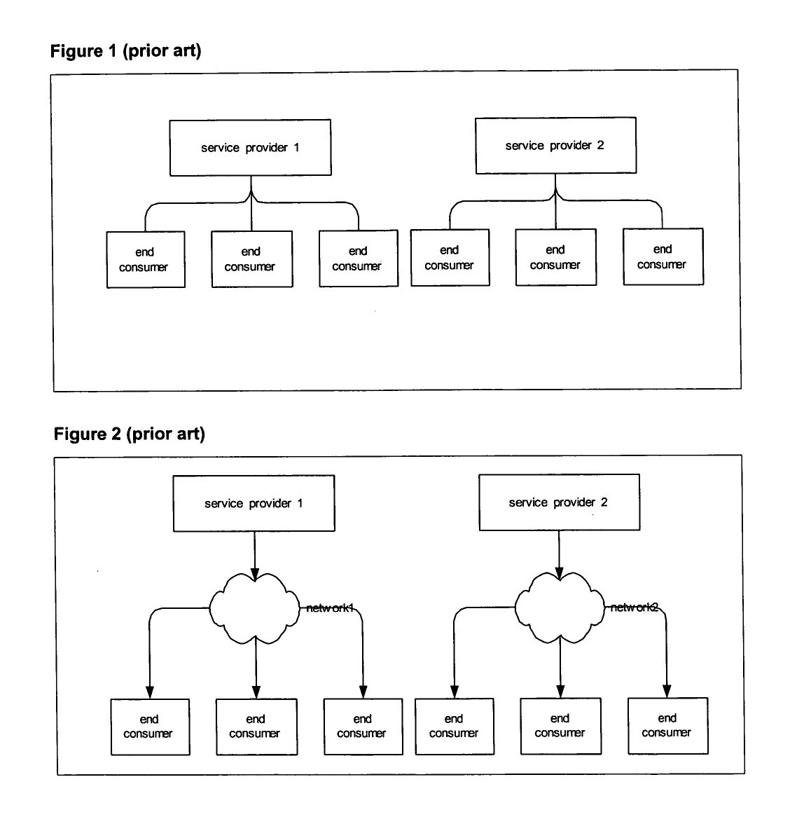

FIG. 5 shows the data model used in current rating engines.
Customer models an end customer of the service provider.
Balance models the liabilities of an end customer due the service provider since the customer is always the buyer. Note that there is no balance explicitly associated with the service provider to show the amount due to it because all customer balances are assumed to be due the service provider.
Product type models a product sold by the service provider. A product model defines the resource types consumed when a product is consumed by a customer.
Product instance records a specific purchase option, i.e., a particular price plan selected by a customer to purchase units of a specific product type. The attributes of a specific product instance identify a customer and the price plan he/she selected. Identification of the customer can be by instance-specific data such as phone numbers or cell phone serial numbers.
Price plan models the pricing formula of a product model. A price plan is typically a mathematical function that maps the quantity of resource consumed to a dollar amount. A product model offered by the service provider typically can be purchased under one of several price plans, e.g. lower unit price with higher consumption quantity commitment. When a customer purchases the product, the customer specifies one of the price plans. Therefore, there is a specific relationship between a product instance and a price plan.

FIG. 6 shows the new business relationships across multiple tiers of participants. Participants are represented as boxes and the business relationships between participants are represented by lines. Note that we use the term participant here because each participant can be a seller or a buyer in different business transactions. Resources and payments can flow between any participants that have a business relationship between them.

In addition, there can be supply-chain relationships between the participants where one participant sells a product that consists of parts provided by other participants. Payments collected by the selling participant must be shared with those participants that supply the parts in the sold product. These supply-chain relationships are also represented by lines in FIG. 6.

This business network can be arbitrarily divided into sub-networks. FIG. 6 shows two such sub-networks: subnetwork1 and subnetwork2. Note that there are business relationships between participants in different sub-networks.

FIG. 7 shows the application deployment architecture in order to support the new business relationship model. Each rating engine corresponds to a sub-network in FIG. 6, each supporting multiple participants. Each rating engine computes the individual transaction payments and the net payments due between each pair of participants. In the degenerate case, each rating engine corresponds to a sub-network with only one participant in the sub-network.

The rating engines are now connected via a conduit, which is a data connection between the rating engines. The output of one rating engine can be sent to another rating engine for subsequent processing. By connecting multiple rating engines, the conduit serves to support the business relationships between participants in different sub-networks and connect multiple sub-networks into a complete network. All participants in the business network in FIG. 6 can now conduct business and settle payments.

FIG. 8 shows the data model store in or used by the rating engine in order to track resource usage across multiple tiers of business relationships. Since every participant is a potential seller and a potential buyer, there is no default seller anymore. Therefore, the following enhancements are necessary:
Product types offered for sale must be specifically linked to the participant that offers the product for sale.
Since any participant can be a seller, each balance must have a debtor and a creditor relationship, the debtor and creditors being the two entities involved in the particular tier of the value chain to which the balance object pertains. Each seller will have a set of related balances to model who owes how much to whom.

FIG. 9 shows the sample usage record (Resource Detail Record) format that includes at least following parameters:
Parameter that identifies the supplier of resources, labeled Supplier ID (410);
Parameter that identifies the recipient of resources, as labeled Customer ID (420);
Parameter that identifies the end consumer of resources, as labeled Consumer ID (430).
Parameter that identifies additional suppliers of resources, labeled Other Participant ID fields (441);
Parameter that identifies the resource type (432);
Parameter that identifies the resource quantity (440);
Parameter that identifies the time of the transaction to which the RDR pertains.

The Supplier ID and Other Participant ID are important new information because they enable credits to be properly recorded in the data model described in FIG. 8. With the previous data format, credits can only be recorded against the default seller. When there are multiple sellers in the business network, there is no default seller and the RDR must explicitly identify the seller(s).

FIG. 10 shows the use of the inventive system (110) in tracking and accounting for the resources flow across a set of arbitrary supplier-customer relationships in a value chain (130). Usage records are collected from probes in the value chain and imported into the inventive system (120).

FIG. 11 shows the structure of the inventive system, which consists of an accounting processor (240) and a number of modules that are used to configure the accounting processor. The configuration modules include but not limited to account management module (210), pricing management module (220) and value chain management module (230) and are used to configure the accounting processor (240). The accounting processor is used to keep track of the resource usages and calculate the charges and revenues.

FIG. 12 shows an example construction of the accounting processor, which consists of one or more pre-processors (310), an event router and scheduler (320) and one or more interconnected rating elements (330). The pre-processors are used to process or normalize a variety of RDRs into ones with a uniform format. Once normalized, these internally standardized RDRs can be routed to one or more rating elements with certain time constraints. The rating element is used to calculate the charge and revenue associated with an transaction event, based on pricing plan and end consumer profile information stored in a database (340). The rating elements can be arranged in parallel, serial and/or loop configuration. The router's function is to route RDR's through various specialized rating elements and the scheduler's function is to provide sequence and time schedule for processing these RDR's.

FIG. 13 shows that the output rated resource detail record (530) can be either concatenated (540) with the input resource detail record (510) or a separate record, before being forwarded to the next stage of rating.

FIG. 14 shows the function of rating element (620), which calculates charges (630) based on the input resource detail record (650), the related pricing plan (610) and information about the end user (640) who consume the resources.

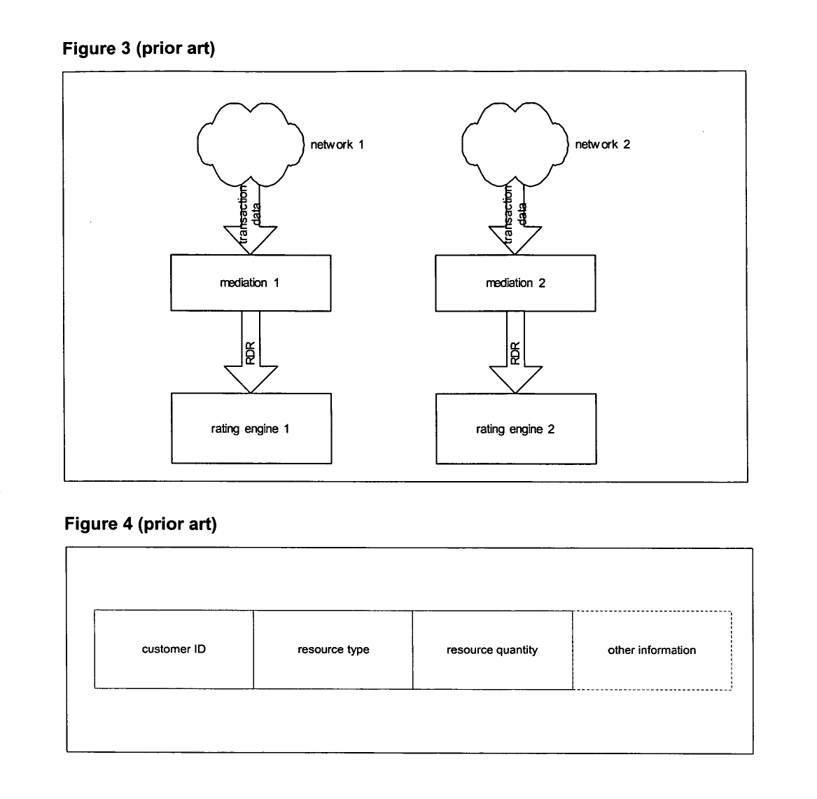

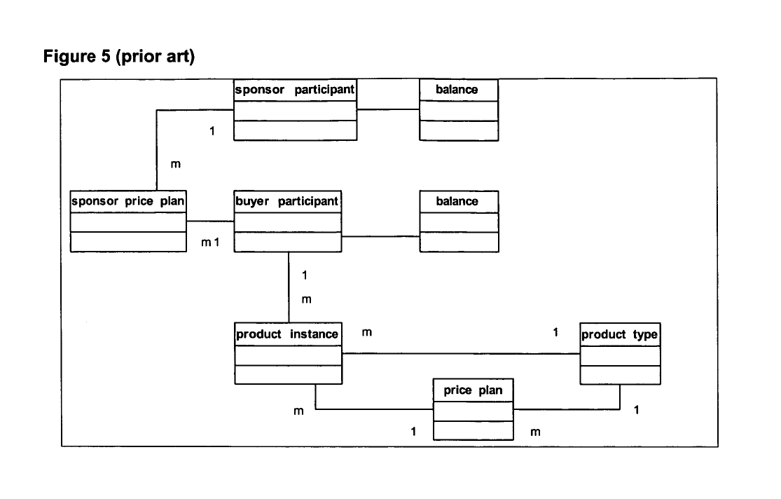

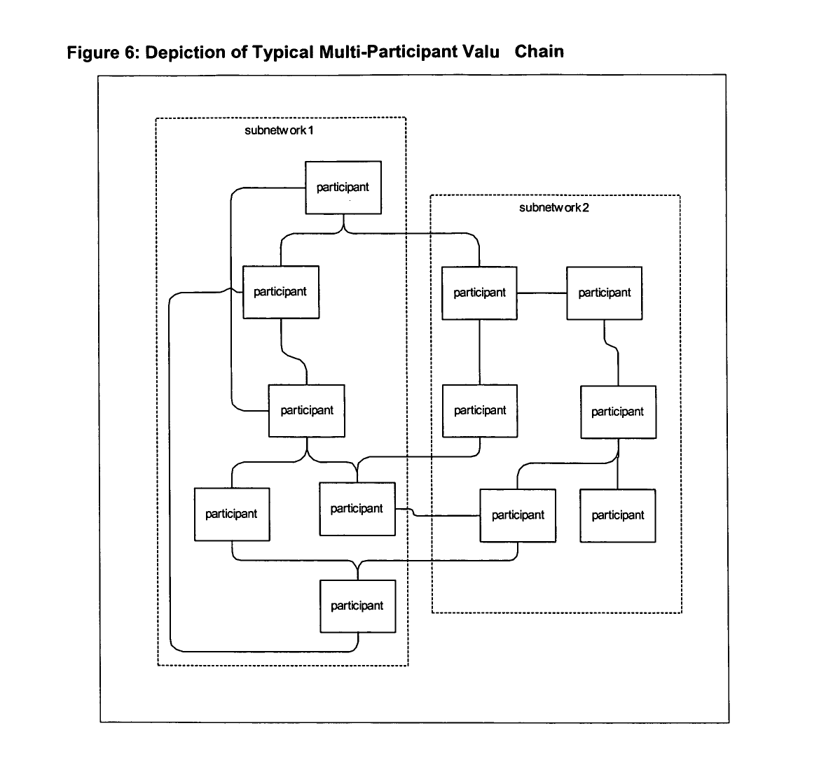

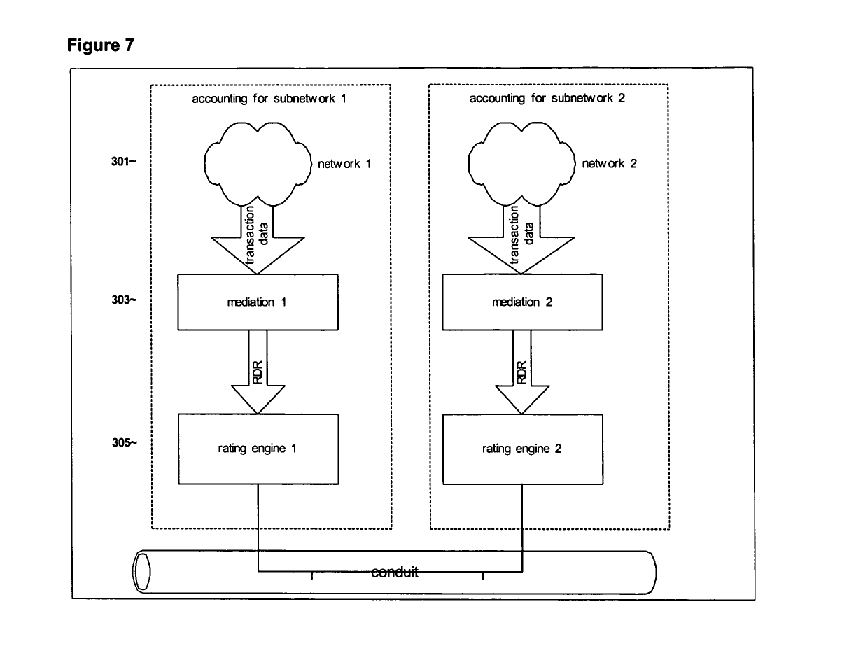

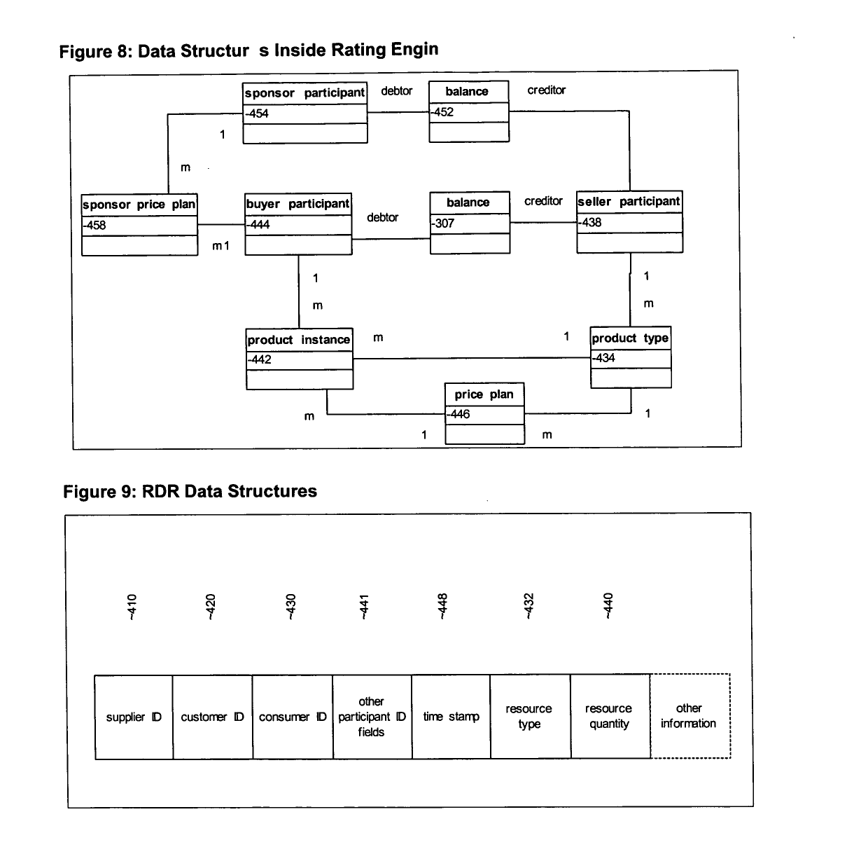

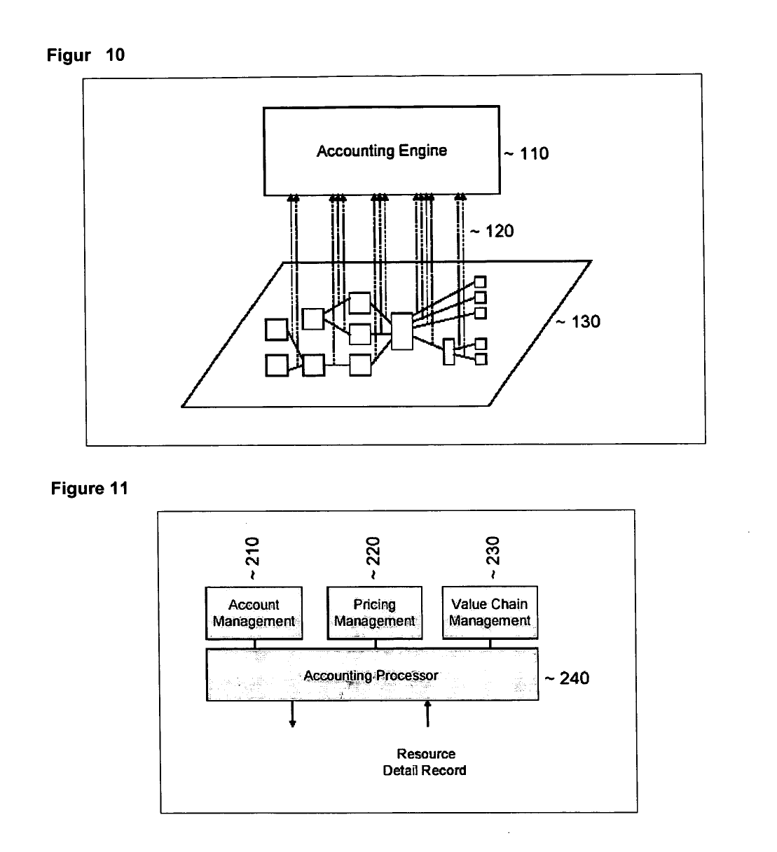

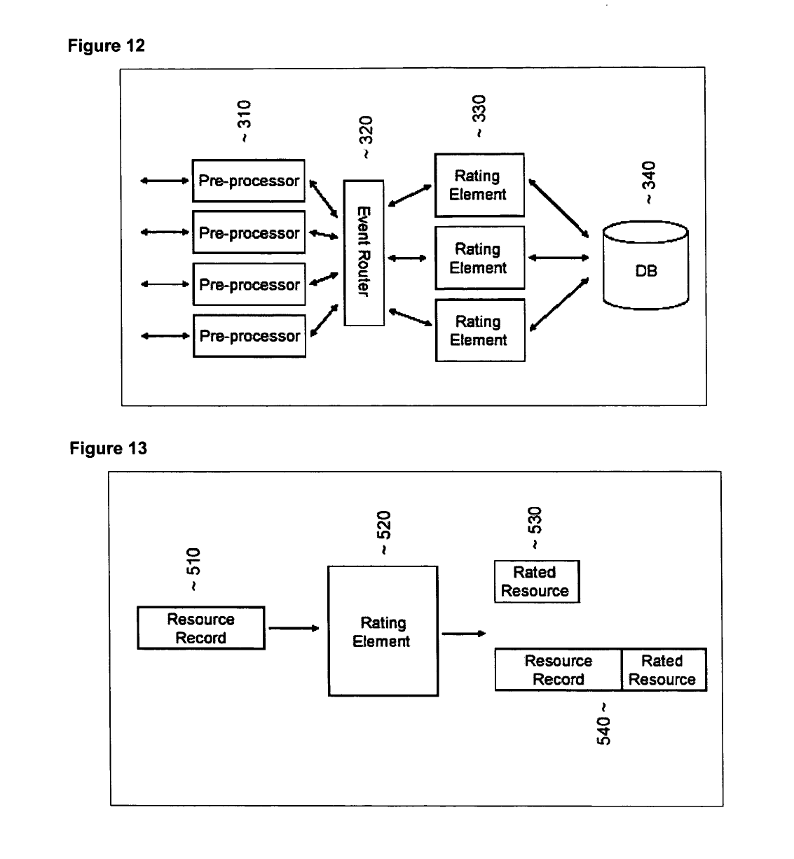

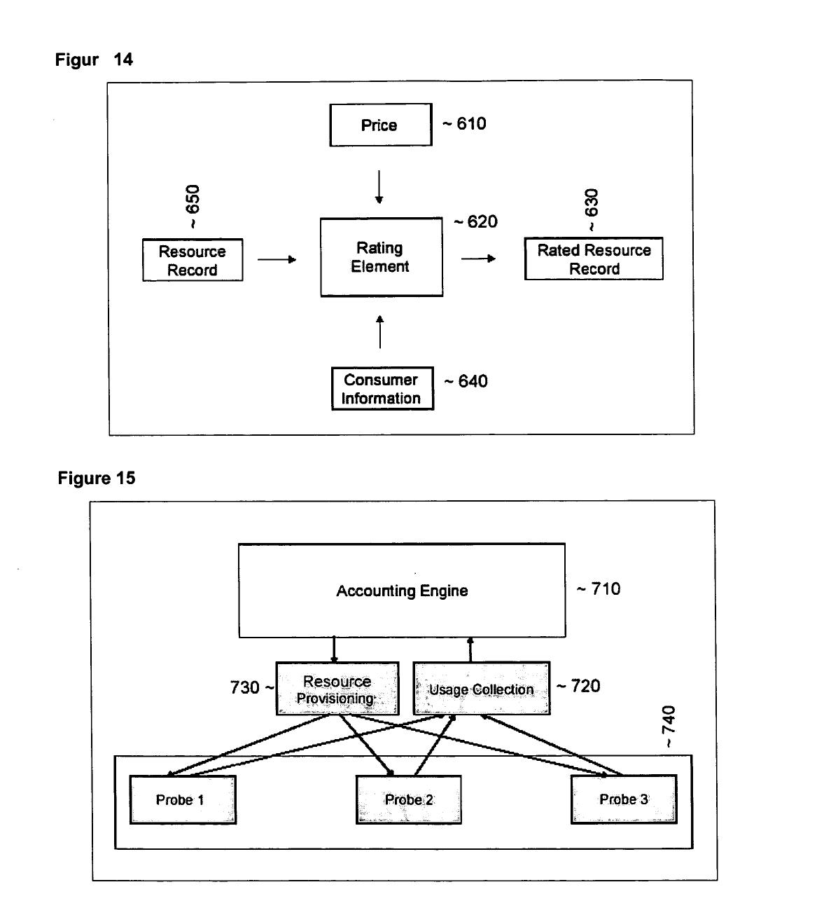

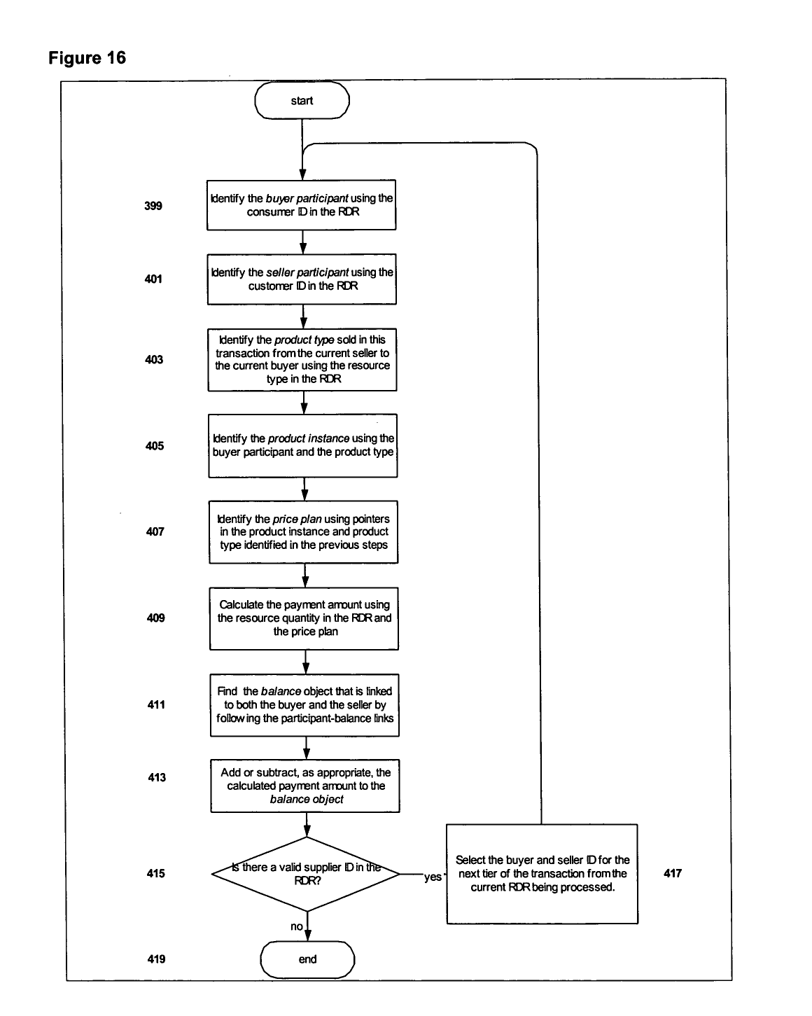

FIG. 15 shows that a usage record collection device (720) may be used to preprocess the resource usage records collected from the probes (740) before sending them to the accounting engine (710). The mediation system in FIG. 3 and FIG. 7 are examples of usage record collection devices.

FIG. 16 is a flowchart of the accounting process carried out by the accounting engine to develop a balance as between each pair of entities on each tier of the value chain.

### DETAILED DESCRIPTION OF THE INVENTION

### Description of the Invention

The inventive system (110) is used to keep track of and account for the resource across arbitrary of supplier-customer relationships (130). Typically, an end consumer requests a transaction that results in resource consumption across multiple supplier-customer relationships. The inventive system determines both actual resource usages and associated charges and revenues. The resource relocation is detailed using a proprietary RDR, which is collected from a set of probe devices strategically placed in the network.

One such inventive system can be used to track and account for resource relocation over one or multiple supplier-customer relationships. The amount of resource used and associated charges and revenues are stored in the database within the inventive system.

The inventive system structurally consists of an accounting processor (240) and a number of configuration modules (210, 220 and 230). The accounting processor is used to calculate the charges and revenues and the configuration modules are used to configure the accounting processor.

More specifically, the account-management module (210) holds the account information for constituents of the said supplier-customer network. The administrator of the inventive system or various constituents can possibly be allowed to manage those accounts under their supervision. Within each account, the users, or the administrator on behalf of the users, can purchase new services and make changes to or cancel existing services. These services are modeled as product instance objects in FIG. 5 and FIG. 8. The user account management module supports account hierarchy so that users within the same organization can be associated with the child accounts and the organization parent account. Charges and resource consumption can be tracked in the parent or child levels to support accurate cost accounting and reporting.

The pricing management module (220) enables the administrator to define purchasable resources in the form of services, products, or packages. The administrator can assign both retail and wholesales prices to each service, product, and package, together with appropriate discount schemes.

The value-chain management module (230) allows a systems administrator to capture supplier and customer relationships using a graphic user interface similar to that used in Computer Aided Design (CAD). Once captured, the graphic user interface allows the administrator to configure business rules and pricing for each supplier and customer. The configuration data are then recorded in a data structure like that shown in FIG. 8. This data structure of FIG. 8, is used in connection with the data in the RDR pertaining to a transaction on the value chain represented by the data structure to control operations of the accounting to calculate balances for every tier of the value chain.

An end consumer transaction typically results in one or more resource relocation within the supplier-customer network and thus generates one or more RDR's. These RDR's are then collected directly or through an independent collection device (720) into the system including the accounting engine.

Once imported, a RDR is first normalized to an internally standardized format by pre-processors (310). The normalized RDR is then examined by Event Router (320) to determine the supplier and customer involved and routed to the appropriate rating elements (330) to be processed within the time constraint specified by the scheduler. Each rating element contains a set of pricing structures defined in a price plan object in the data structure which is linked to the participant data objects in the data structure which embody the supplier-customer relationship being processed.

The rating element is virtualized. A rating element can be implemented in one or multiple hardware computers and a hardware computer can host multiple rating elements. The actual arrangement is determined by the processing load demand for each rating element.

The rating element calculates the charge based on the input RDR, associated pricing plan and the profile information of the end consumer, supplier and customer. The resulting rated RDR can either be used to be the input to another rating element or to the first rating element itself.

The intermediate results and the end results are either stored in a database for later uses or output.

Resource Accounting Processes

The resource accounting over a cascaded business value chain can be accomplished through four separate but related processes. The first process, known as Mediation Process, collects, correlates and aggregates inputs from various network probes and generates RDRs. The second process, known as Accounting Process, processes RDRs based on pricing, discounting, promotion and other terms of agreements between and among participants to the value chain to produce set of detail accounting of financial, monetary and non-monetary, debit and credit to each participant. Inter-relating two processes, RDR provides a protocol of information necessary to communicate between the two processes. The third process, known as Settlement Process, aggregates one or more set of debits and credits in real time per RDR or across a lapse of time over multiple RDRs to determine the relative charges of a participant to another. The final process, known as Reconciliation Process, allows two trading participants in a value chain to compare and reconcile debit and credit with each other using independent, physically or virtually separate, Accounting Processes on a per transaction (i.e, per RDR) or an aggregate over multiple transactions.

Mediation Process

The objectives of Mediation Process are collection of necessary information from the network or server resident probes, correlation and aggregation of the resulting information and production of complete or partial RDRs. Mediation Process is divided into the following four sub-processes:

1. Collection

Collection sub-process involves gathering necessary information for resource accounting from a network of distributed probes strategically placed in a value chain. These probes, either co-located with network elements or inserted into a communication link, monitor the requests for resource and permission-grants to access the resource and/or meter the amount of resource consumed. These probes can be co-located with specialized network switches and routers such as GGSN, SGSN, MSC, and MMSC, specialized gateways such as BRAS, RADIUS, DIAMETER and WAP, special purpose servers such as content, application and game servers or inserted into a communication link to monitor the requests and permission grants to access resources and meter amount of resource consumption.

2. Correlation

These distributed probes, in spite of being strategically placed, have only information of localized scope. However, resource exchanges taken place across the value chain involved multiple participants and involved a greater scope spanning across multiple local scopes as defined by the probes. To infer the end-to-end nature of these resource exchanges, information collected from the distributed probes must be correlated to ascertain the various characteristics of the resource consumed including type, amount, and time of the resource consumption and participants to the transaction including consumers, suppliers, distributors and others who may have financial interests or obligations.

3. Aggregation

Aggregation sub-process consolidates information related to a transaction from multiple probes to produce a single RDR and optionally accumulates multiple RDRs into a batch. Such aggregation sub-process reduces the volume of information to the most essential and compact for efficient transmission to Accounting Process.

4. Formatting

Before RDRs can be transmission to Accounting Process, Mediation Process also formats the RDRs in such way that they are compressed and secured during the transmission and can be decoded after the transmission. The sub-process is also necessary to format the resource consumption information according to a standard protocol.

Resource Detail Record

Resource Detail Record completely describes a resource exchange transaction including time of the transaction, type and amount of resource involved and participants involved in the transaction. An RDR has the following attributes:
Time stamp for the transaction
End user ID who initiates the transaction
Type of resources consumed
Amount of resources consumed
Qualitative description of the resource consumed such as Quality of Service, speed and capacity of the resource
Underlying network routing to support the transaction
Participants to the transaction including end user who initiates the transaction, suppliers who contributed to the resource, distributors who transport resource from across its network and hence contribute network resources, retailers who sell the resource under their brand-names and advertisement placement agencies who sponsor partially the charges.

It is possible to have a repeated array of the attributes aforementioned in one Resource Detail Record to describe a resource exchange transactions in multiple tiers of transactions.

Accounting Process

The objective of Accounting Process is to determine the financial impacts on every participant to the value chain as resulted from a transaction. In general, four roles participants play in supporting a transaction—buyer, seller, sponsor and claimer. The buyer buys and consumes resource from the seller. The seller sells and provides resource which may or may not owned by the seller itself. In the case when the seller does not own the resource, the resource is supplied by one or more third party suppliers which all have claims on the charge made by the seller on the buyer. The amount of the charge these claimers are entitled are determined by the wholesales supply contracts between the seller and its suppliers. The sponsor shares the financial obligation with the buyer and thus pays a portion of the charge.

The participants' roles can be changed dynamically from one transaction to another. A buyer in a given transaction could be a seller in another. As such, the Accounting Process for a given transaction can be further divided into the following seven sub-processes. These sub-processes will be described referring jointly to FIGS. 7, 8, 9 and 16.

When a transaction occurs, probes in the network pick up data about the transaction and send the data to the mediation process 303 in FIG. 7. The process of probes picking up data is symbolized by cloud 301 in FIG. 7. The probes are prior art processes. The probes used depend on the type of the network. If a telephony network is involved, the probes manufactured by Lucent, Ericsson, . . . etc. can be used. If the transaction occurs over the Internet, the probe technologies in prior art e-commerce engines can be used to gather the transaction data.

The data received from the probes are converted into RDR by the mediation process 303 described above. The mediation process 303 is the prior art mediation process modified to output the RDR shown in FIG. 9.

The RDRs output by the mediation process are like network packets received by the rating engine 305 in FIG. 7. In a transaction that involves more than two entities in the value chain, there will be at least one RDR generated for each transaction between a buyer-seller pair. The rating engine processes the RDRs by using identification codes therein as pointers to various objects shown in FIG. 8. The computer follows the process of FIG. 16 to use the data fields in the RDRs and the data structures in FIG. 8 to make the accounting calculations to derive the monetary balance stored in the balance object 307 in FIG. 8. We now turn to a focus on the process of using the RDRs and the data structures in FIG. 8 to do the accounting calculations.

1. Identification of Buyer Account

Referring to FIG. 16, there is shown a flow chart of the overall accounting process to use information in the RDRs and the data structures in FIG. 8 to calculate balances for every participant in the transaction. The process of FIG. 16 processes one RDR at a time. Assume the transaction involved is NASDAQ supplies streaming stock quotes to Sprint PCS servers who receives request from cell phone users for stock quotes and sends packets over a wireless network to the requesting cell phone to display the requested stock quote. In this hypothetical scenario, the supplier ID 410 in FIG. 9 identifies NASDAQ. The customer ID 420 identifies Sprint PCS, and the consumer ID 430 identifies the cell phone user who requested the stock quote.

The first sub-process is to identify the buyer account using the consumer ID provided by RDRs, as symbolized by step 399. To accomplish this, the rating engine 305 in FIG. 7 receives a RDR regarding the transaction and reads the consumer ID 430. The buyer account would ultimately be responsible for the retail charge.

2. Identification of Seller Account

Next, step 401 is performed to identify the seller entity. This is done by reading the customer ID 420 in FIG. 9. This identifies Sprint PCS as the seller.

3. Identification of Sponsor Accounts

Based on the buyer's profile and the products acquired by a buyer, a sponsor account can be identified together with the terms of sponsorship. A sponsor is an entity that promises to pay portions of the expenses on behalf of the buyer. In the hypothetical example, there are no sponsors, but a sponsor in the hypothetical example might be an employer who promises to reimburse all cell phone charges during work hours.

4. Determination of Product Type

The line of processing in FIG. 16 processes only a transaction between two entities: a buyer and a seller using a single RDR that stores data regarding the transaction. Step 403 in FIG. 16 represents the process of determining which product type was sold by the current seller in the transaction being processed. This is done by first reading the resource type field 432 in FIG. 9. This resource type field points to the product type object 434 in FIG. 8. The data structure of product type object 434 includes a field which has a pointer 436 to the seller participant object 438. This chain of reads verifies the product type sold by this particular seller in this particular transaction.

5. Determination of Product Instance

Every product type can have multiple instances thereof that are sold in one or more transactions. A product instance is a data object in the rating engine data structure that records the choice of a particular price plan by a particular customer. To calculate the charge we need to know how many instances of the product type identified in step 403 were sold by the seller identified in the steps previously described. To do this, step 405 in FIG. 16 is performed. This step finds the product instance involved in this transaction in any way. One way is for the consumer ID 430 to point to the product instance 442 in FIG. 8. Another way is for the consumer ID 430 to point to the buyer participant data object 444 in FIG. 8, and then do a search of all product instances to see which product instance object have points to the buyer participant object 444. Next the product instance objects found in the search are re-examined to determine which ones have pointers to the product type object 434 in FIG. 8 which is involved in the transaction currently being processed. Recall that the product type object was determined earlier in step 403. This search reveals which product instance object is involved in the transaction currently being processed.

6. Determination of Buyer Charge

Next it is necessary to determine the buyer charge for this transaction. Every transaction has a charge that is determined by the terms of the price plan governing that particular transaction. The particular price plan that determines the terms of the transaction depends upon the product type and the product instance. The difference between product type and product instance can be best understood by an example. In the hypothetical example of NASDAQ streaming stock quote to a cell phone, product type would be data packet delivery (vs. voice minutes also delivered as packets). The product instance is an object that has data that defines a particular cell phone number and another field which points to a particular plan that the buyer chose for that particular cell phone. Assume in the hypothetical there are two price plans for data delivery: (1) unlimited stock quote for $59.99 per month; (2) $0.10 per stock quote delivered. The quantity field 440 in FIG. 9 represents the number of stock quotes delivered in the case of transaction priced at $0.10 per stock quote. To calculate the charge we need to determine the price plan that pertains to this transaction. The price plan is determined by following pointers in the product type object 434 previously determined and the product instance object 442 previously determined. The price plan contains the actual charge per unit for the particular product instance involved in the transaction being processed. To calculate the charge, the price per unit is read from the price plan 446 just identified, and that number is multiplied by the quantity or number of units of this product type consumed, as indicated in data field 440 of FIG. 9. Another example for calculating the charge would be GPRS service (delivery of data packets to cell phones) priced at $0.50 per kilobyte for peak hours and $0.30 at off-peak hours. In this example, the time stamp field 448 in FIG. 9 comes into play. In this example, the time stamp information is read from field 448 in FIG. 9 and then the price plan is read from data object 446 in FIG. 8. The appropriate price per unit is selected from the price plan by comparing the time stamp to constants which define peak and off-peak hours. The appropriate price per unit is then multiplied times the quantity of units consumed as recorded in field 440 of the RDR in FIG. 9. The whole process described in this paragraph is represented by steps 407 and 409 in FIG. 16.

7. Find and Adjust the Balance Object Between Buyer and Seller

We follow a pointer from the buyer object 444 in FIG. 8 to balance object 307. This balance object records a monetary balance between buyer 444 and seller 438. We then add or subtract, as appropriate, the charge calculated in the previous step to the monetary balance stored in the balance object 307. These steps of locating the appropriate balance object and adjusting the balance therein are represented by steps 411 and 413 in FIG. 16.

8. Determination of Sponsors' Charge Obligation

The sponsor's portion of financial obligation for the end user charge can be determined by the terms of sponsorship and the quantity of resource consumed or the total charge. A simple example of the sponsorship may consist of a percentage of the total charge. In this example of streaming stock quotes to the cell phone, there is no sponsor. However, if there was one, assume that the sponsor will be represented by data object 454 in FIG. 8. To calculate the sponsor's charge, the buyer object 444 would be accessed and a pointer therein followed to a data object 438 representing the sponsor price plan. The rate per unit for the sponsor participant would be read from the sponsor price plan object 438. That rate per unit would be multiplied by the quantity of resources consumed in this transaction. Then a pointer in the sponsor price plan object 438 would be followed to a balance object 452 which records the balance between seller 438 and sponsor 454. The calculated monetary amount would then be added or subtracted, as appropriate, to the balance shown in balance object 452.

9. Transition to the Next Tier of the Transaction, If Any

If there are more than two entities in the transaction, then it is necessary to calculate the charges for the pair of entities at the next tier. If there is a next tier, it will be indicated by the presence of a supplier ID 410 in FIG. 9. Step 415 in FIG. 16 represents the process of determining if there is a next tier in the transaction by reading the supplier ID 410 and determining if it is valid. If it is valid, processing transition to step 417.

Step 417 represents the process of obtaining two new entity ID from the RDR currently being processed for the transaction. This can be done in several ways. One way is to erase the consumer ID 430 and shift the customer ID 420 into field 430 and shift the supplier ID in field 410 into field 420. Another way is to copy the RDR in FIG. 9 and read field 420 from the original and write that into field 430 in the copy, and then read field 410 of the original and copy it into field 420 in the copy. Or if there are repeated records of resource usage information in the RDR, the process can shift to the next record in the RDR for the next stage of processing. Process then returns to step 399 and the transaction is then processed using these two ID.

If step 415 determines that there is not a valid supplier ID in the current RDR and there is 10 no more repeated records in the RDR, it means there is no next tier in the transaction. This will cause processing to transition to step 419 where the process terminates.

Improvements Over Prior Arts

The inventive system has a number of improvements over the prior art including but not limited to:
1. The inventive system keeps track of resources and revenues across the whole value chain, whereas all existing billing and charging systems in the market only keep track of resources and revenues over one tier of the value chain. These systems were originally developed to keep track of resources and revenues between a single service provider and its subscribers.
2. The inventive system keeps track of resources and revenues and settles among participants in the value chain in real time, whereas most of the billing systems are batch-mode based. As next-generation services are delivered in real time and interactively, the accounting system must be able to support real-time resource and revenue tracking and settlement.
3. The inventive system supports real-time multiparty settlement for a wide selection of services, whereas most of these accounting systems today are custom built by wireless roaming operators and clearing houses and are designed specifically for particular services such as settling voice minutes.
4. The inventive system supports arbitrary supplier-customer networks with a wide variety of business models. The supported network types include but not limited to value chain model, peer-to-peer model and exchange model.
5. The inventive system supports arbitrary and mixed resources including network-based resources, digital goods and physical goods.
6. The inventive system provides information about revenue, cost and contribution margin on per service/product, per partner and per channel bases, while the prior arts can only provide revenue information.

Applications

The inventive system can be used in a wide range of applications to keep track of and account for resources over arbitrary supplier-customer network. Exemplary applications include but not limited to the following:
1. Next generation wireless—Next generation wireless carriers outsource content and applications and use channels extensively. The complex value chain requires resource tracking and accounting over a complete value chain.
2. Wireless GPRS roaming—GPRS roaming operators use carrier-partners as channels to the end users.
3. Web services—Web services enable enterprises and service providers to aggregate external services dynamically. The inventive system would be required to keep track of the external resources.
4. Grid computing—Grid computing enables an organization to aggregate large amount of external computing resources. The extensive use of external suppliers is ideal for application of the inventive system.
5. Market Places—marketplaces aggregate sellers' goods and buyers' demand. From a marketplace operator's perspective, the sellers are suppliers and buyers are customers and the inventive system is required for settlement amount the buyers and sellers.
6. B2B exchange—B2B exchange provides a place for multiple marketplaces to exchange their goods and services and thus requires multi-party settlement function provided by the inventive system.

1. A computer readable medium having stored thereon a data structure comprising:
two or more fields, each containing data representing the identification code of a seller and a buyer of a transaction that crosses business boundaries and wherein said two or more fields may also contain identification codes of other participants in said transaction such as distributors, claimants, retailers, syndicates or advertising placement agencies;
a field containing data defining the type of resource consumed;
a field containing data defining the amount of resource consumed.

2. The medium of claim 1 wherein said data structure stored thereon further comprises: a field containing data defining the time for said transaction.

3. The medium of claim 2 wherein said data structure further comprises:
a field containing data providing a qualitative description of the resources consumed such as quality of service, speed, or capacity of a delivery network consumed in delivering said resource.

4. The medium of claim 1 wherein said data structure stored thereon further comprises:
a field containing data defining the underlying network routing used to carry out said transaction.

5. A computer readable medium having stored thereon a data structure comprising:
a plurality of fields, each containing data representing an identification code of a participant in a transaction on a value chain, said fields including at least a supplier identification code, a customer identification code, a consumer identification code, and fields containing identification codes for any other types of entities involved in the transaction;
a field containing timestamp data indicating when said transaction occurred;
a field containing data indicating a type of resource consumed; and
a field containing data indicating a quantity of resource consumed.

6. The computer readable medium of claim 5 wherein said fields containing the identification codes of other participants in said transaction includes fields which store identification codes of:
one or more distributors who distributes said resource;
one or more retailers who sells said resource to said consumer;
one or more claimants who supplies goods or services to any of said supplier, distributor or retailer in support of said transaction and who has a claim on the revenues earned from said transaction by said supplier, distributor or retailer;
one or more advertising placement agencies who participate in said transaction by advertising;
and wherein there may be multiple fields for each type participant, each containing a different identification code of a different participant of the same type and wherein the number of said fields equals the number of participants in said transaction and only fields for participants in a transaction are present.

7. A computer readable medium having stored thereon a data structure comprising at least the following objects:
one or more balance objects, each comprising a plurality of fields, at least one of which contains net balance data that defines the net balance of debits and credits for a transaction between a first participant who is a buyer or debtor in said transaction and a second participant who is a seller or creditor in said transaction, said transaction being in a value chain having at least two participants, at least one field in each said balance object containing data pointing to an address in memory where data regarding said first participant is stored, at least a second field containing data pointing to an address in memory where data regarding said second participant is stored, and wherein each debtor participant may have multiple balance objects associated therewith, and wherein each creditor participant may have multiple balance objects associated therewith;
one or more debtor objects, each comprising a plurality of fields that contain data that identify a particular debtor in said transaction and which contain attribute data regarding said debtor, at least one field in each debtor object data pointing to a pertinent balance object recording a debit/credit balance between said debtor and a creditor represented by a creditor object in said data structure, and wherein each debtor object may contain pointers to multiple balance objects each of said balance objects recording a debit/credit balance between said debtor and a particular creditor;
one or more creditor objects, each comprising a plurality of fields that contain data that identify a particular creditor, and each of which contains attribute data of said creditor, at least one field in each said creditor object pointing to a pertinent balance object which stores a debit/credit balance between said creditor and a debtor represented by a debtor object in said data structure, and wherein each said creditor object may contain pointers to multiple balance objects;
one or more product type objects, each comprising a plurality of fields that contain data that define a type of product or resource consumed in said transaction, each product type object having at least one of said fields containing data that points to a pertinent creditor object for a creditor that sells or licenses or leases or otherwise distributes the type of resource involved in said transaction, and wherein multiple product type objects can point to the same creditor object;
one or more product instance objects, each comprised of a plurality of fields that contain data that define a choice by a consumer of a particular price plan for consumption of a resource in said value chain, at least one of said plurality of fields containing data pointing to a price plan object, and at least one of said plurality of fields containing data pointing to a product type object, and at least one of said plurality of fields containing a pointer to a debtor object; one or more price plan objects, each of which comprises a plurality of fields that contain data that define a price plan defining the price per unit for consumption or purchase of a particular type of product or resource which may be consumed in said transaction, each said price plan object having a field containing a pointer to a pertinent product type object.

8. The computer readable medium of claim 7 wherein said data structure further comprises:
one or more sponsor data objects, each of which comprises a plurality of fields that store data identifying and defining attributes of a sponsor participant in said value chain, at least one field of each said sponsor data object containing a pointer to a sponsor price plan object, and at least one field of each sponsor data object containing a pointer to a balance data object;
at least one balance data object corresponding to each sponsor data object, each balance data object storing data defining a debit/credit balance between a sponsor identified by said corresponding sponsor data object and a seller identified by a corresponding seller data object, at least one field of each said balance data object containing a pointer to said corresponding seller data object and at least one field containing a point to said corresponding sponsor data object; and
at least one sponsor price plan containing price per unit data for financial terms which represent a relationship between a sponsor and a seller object, each sponsor price plan comprising a plurality of fields at least one of which contains a pointer to a corresponding sponsor data object.

9. A process for computing accounting information pertaining to a transaction that crosses business boundaries in a value chain having two or more participating businesses or entities, comprising the steps:
(1) identifying a buyer participant in a transaction that crosses business boundaries using the consumer identification code in an RDR data structure recording data of said transaction;
(2) identifying a seller participant in said transaction using a customer identification code in said RDR data structure recording data of said transaction;
(3) identifying a product type involved in said transaction;
(4) identifying a product instance involved in said transaction;
(5) identifying a price plan which records data defining the terms which govern calculation of charges for units of said product type consumed in said transaction;
(6) calculating a payment amount using a price per unit from said price plan and a number of units consumed from said RDR recording data pertaining to said transaction;
(7) finding a balance object which records the monetary balance as between said buyer participant and said seller participant in said transaction, and adding or subtracting the calculated payment amount to a balance recorded in said balance object, as appropriate;
(8) determining if there is another tier in said value chain;
(9) if there is another tier in said value chain, selecting two participant identification codes for participants on said tier and repeating steps (1) through (7) using said RDR and said two participant identification codes selected in this step 9 as said consumer and customer identification codes as appropriate;
repeating steps (8) and (9) as many times as is necessary to process account balances between all participants on all tiers in said value chain.

10. The process of claim 9 wherein said step of identifying a product type is accomplished by reading a resource type field in said RDR data structure.

11. The process of claim 9 wherein said step of identifying a product instance is accomplished by searching all product instances data objects for ones which have pointers-to said buyer participant involved in said transaction, and searching the resulting product instance data objects for the one which has a pointer to said product type involved in said transaction.

12. The process of claim 9 wherein said step of identifying a price plan involves following pointers in said product type and product instance data objects which both point to a data object recording the appropriate price per unit price plan pertaining to this transaction.

13. The process of claim 9 wherein said step of determining whether there is another tier in said value chain comprises determining if there is a valid supplier ID in said RDR.

14. The process of claim 9 wherein step (9) comprises copying the current RDR to a new RDR but shifting the participant IDs so that the original customer ID is the consumer ID in the new RDR and the supplier ID in the original RDR is the customer ID in the new RDR or just modifying original RDR by shifting the participant IDs so that the customer ID in the original RDR is shifted to the consumer ID field in the modified RDR and the supplier ID in the original RDR is shifted to the customer ID field in the modified RDR.

15. A computer readable medium having computer-executable instructions stored thereon for controlling a computer to perform a method comprising the steps:
(1) identifying a buyer participant in a transaction that crosses business boundaries using the consumer identification code in an RDR data structure recording data of said transaction;
(2) identifying a seller participant in said transaction using a customer identification code in said RDR data structure recording data of said transaction;
(3) identifying a product type involved in said transaction;
(4) identifying a product instance involved in said transaction;
(5) identifying a price plan which records data defining the terms which govern calculation of charges for units of said product type consumed in said transaction;
(6) calculating a payment amount using a price per unit from said price plan and a number of units consumed from said RDR recording data pertaining to said transaction;
(7) finding a balance object which records the monetary balance as between said buyer participant and said seller participant in said transaction, and adding or subtracting the calculated payment amount to a balance recorded in said balance object, as appropriate;
(8) determining if there is another tier in said value chain;
(9) if there is another tier in said value chain, selecting two participant identification codes for participants on said tier and repeating steps (1) through (7) using said RDR and said two participant identification codes selected in this step 9 as said consumer and customer identification codes as appropriate;
repeating steps (8) and (9) as many times as is necessary to process account balances between all participants on all tiers in said value chain.

16. The computer readable medium of claim 15 wherein the computer-executable instructions stored thereon further control a computer to execute the following steps:
identifying a product type by reading a resource type field in said RDR data structure.

17. The computer readable medium of claim 15 wherein the computer-executable instructions stored thereon further control a computer to execute the following steps:
identifying a product instance by searching all product instances data objects for ones which have pointers to said buyer participant involved in said transaction, and searching the resulting product instance data objects for the one which has a pointer to said product type involved in said transaction.

18. The computer readable medium of claim 15 wherein the computer-executable instructions stored thereon further control a computer to execute the following steps:
identifying a price plan by following pointers in said product type and product instance data objects which both point to a data object recording the appropriate price per unit price plan pertaining to this transaction.

19. The computer readable medium of claim 15 wherein the computer-executable instructions stored thereon further control a computer to execute the following steps:
determining whether there is another tier in said value chain by determining if there is a valid supplier ID in said RDR.

20. The computer readable medium of claim 15 wherein the computer-executable instructions stored thereon further control a computer to execute the following steps:
copying the current RDR to a new RDR but shifting the participant IDs so that the original customer ID is the consumer ID in the new RDR and the supplier ID in the original RDR is the customer ID in the new RDR or just modifying original RDR by shifting the participant IDs so that the customer ID in the original RDR is shifted to the consumer ID field in the modified RDR and the supplier ID in the original RDR is shifted to the customer ID field in the modified RDR.
